(19) United States
(12) Patent Application Publication
(10) Pub. No.: US 2014/0367244 A1
(43) Pub. Date: Dec. 18, 2014

(54) Controlled Thin Film Vapor Generator for Liquid Volume Reduction

(71) Applicant: R3 Fusion, Inc., Troy, NY (US)

(72) Inventor: Roshan J.J. Jachuck, Troy, NY (US)

(21) Appl. No.: 14/308,287

(22) Filed: Jun. 18, 2014

Related U.S. Application Data
(60) Provisional application No. 61/836,640, filed on Jun. 18, 2013.

(51) Int. Cl. B01D 1/00; C02F 1/08; B01D 3/00; B01D 1/22; B01D 1/28

(52) U.S. Cl. CPC B01D 1/0064; B01D 1/22; B01D 1/28; B01D 3/007; C02F 1/08; C02F 2103/06
USPC 203/10; 203/89; 159/13.1; 159/49; 202/236; 202/177; 202/172; 202/173

(57) ABSTRACT

A reactor comprising a vessel; a fluid dispensing system having a plurality of ports arranged lengthwise along the inner surface of the vessel to distribute the fluid thereon in a controlled manner to maintain substantially uniform thin film flow along the length of the inner surface; and an outlet for removing vapor. A system comprising a fluid source; a first vessel; a heat exchanger for preheating the fluid; a first pathway for directing a preheating fluid from the first vessel to the heat exchanger; and a second pathway for directing preheated fluid toward the first vessel for processing. A method comprising introducing a fluid; distributing the fluid in a controlled manner to form a substantially uniform thin film flow an inner surface of a vessel; evaporating fluid; and removing vapor. A method comprising introducing a fluid; processing the fluid; directing processed fluid into another vessel; and further processing the fluid.

### CROSS-REFERENCE TO RELATED APPLICATION

This application claims priority to U.S. Provisional Patent Application No. 61/836,640, entitled “Controlled Thin Film Vapor Generator For Liquid Volume Reduction,” filed on Jun. 18, 2013, which is hereby incorporated by reference for all purposes.

### TECHNICAL FIELD

The present invention relates to processing reactors, and more particularly, to continuous processing reactors that can impart fluid being processed with high heat transfer and high transport rates. The present invention relates, in particular, to the use of thin film heat transfer for producing vapors, which can be vented, condensed or compressed and can act as a continuous source for the generation of vapor, and for continuous evaporation or distillation of fluids.

### BACKGROUND

A common problem in chemical reaction processes is how to achieve the proper hydrodynamics in the reactor to efficiently produce the desired products. In evaporators, for example, non-uniform evaporation of a fluid against the heat transfer surface causes unwanted drying and scaling about the heat transfer surface. For example, as evaporation takes place in conventional thin film reactors, the film thickness of the liquid film undergoing evaporation is continuously reduced. In extreme cases, the reduction in the film thickness creates a dry spot, which eventually results in scaling of the heat transfer surface evaporate surface and corrosion.

Accordingly, there is a need for a thin film reactor with a design that can provide substantially uniform thin film distribution of the fluid or material to be evaporated or condensed onto the heat transfer surface, that can reduce drying or scaling of the fluid precipitate over the heat transfer surface, and that can provide relatively high transport rates, while providing high throughputs.

### SUMMARY OF THE INVENTION

The present disclosure is directed to a reactor for processing a fluid. The reactor, in various embodiments, may comprise a vessel having an inner surface serving as a heat exchange surface for a fluid being processed and along which the fluid being processed can form a thin film flow; a fluid dispensing system, situated within the vessel, having a plurality of ports directed toward the inner surface and being arranged lengthwise along the inner surface to distribute the fluid being processed against the inner surface in a controlled manner to maintain substantially uniform thin film flow along the length of the inner surface; and an outlet for removing, from the vessel, vapor generated from the fluid being processed.

In an embodiment, the inner surface of the vessel may include a profiled pattern to create additional surface area over which the fluid being processed can flow to facilitate one of treatment, processing, separation, an increase in residence time, or a combination thereof. In another embodiment, the inner surface of the vessel may be coated to facilitate treatment, processing, and/or separation of the fluid being processed.

The fluid dispensing system, in an embodiment, may be rotatable so that substantially fine droplets or fiber-like elements from the fluid being processed can be dispensed from the ports. In various embodiments, the plurality of ports may be arranged in a helical pattern lengthwise along the inner surface of the vessel.

The substantially uniform thin film, in an embodiment, may permit the fluid being processed to exhibit a high rate of one of thermal transfer, mass transfer, mixing, or a combination thereof. In another embodiment, the substantially uniform thin film may enhance the ability of the fluid being processed to be treated, processed, and/or separated.

The reactor may further include, in various embodiments, an outlet positioned on a bottom portion of the vessel for removing processed fluid from the vessel. The outlet for removing generated vapor may, in an embodiment, be positioned on the bottom portion of the vessel. In another embodiment, the outlet for removing generated vapor may be positioned on a top portion of the vessel.

The reactor may further include, in various embodiments, a demister for separating aerosolized fluid from the generated vapor. The demister, in an embodiment, may be substantially cylindrical in shape and placed over the outlet through which vapor generated from the fluid being processed is removed from the vessel. In another embodiment, the demister may be positioned across an opening of the outlet. In yet another embodiment, the demister may be positioned between the inner surface of the vessel and the outlet and may minimize droplets generated by backsplash from being directed into the outlet. The reactor may further include, in an embodiment, a baffle placed within the vessel about the outlet, so as to provide a barrier that prevents fluid separated from the generated vapor by the demister from exiting through the outlet.

The vessel of the reactor may include, in various embodiments, an outer surface along which a heat exchange fluid may be in contact, the heat exchange fluid having a temperature different from that of the fluid being processed to impart a temperature differential between the outer surface and the inner surface of the vessel. In an embodiment, the vessel may include an energy source provided about the vessel to act as a source for a source for creating a temperature differential between an outer surface of the vessel and the inner surface of the vessel. In an embodiment, the energy source may include a jacket.

In another aspect, the present disclosure is directed to a system for processing a fluid. The system may comprise a fluid source for accommodating a fluid to be processed; a first vessel for processing the fluid from the fluid source, the first vessel having an interior surface against which the fluid to be processed is directed in a thin film flow; a heat exchanger, in fluid communication with and located in proximity to the first vessel, for preheating the fluid to be processed from the fluid source; a first pathway for directing a preheating fluid from the first vessel to the heat exchanger to increase the temperature of the heat exchanger; and a second pathway for directing the fluid to be processed received from the fluid source and heated by the heat exchanger, toward the first vessel for processing. The preheating fluid, in an embodiment, may be processed fluid from the first vessel.

In various embodiments, the system may include a heat jacket situated about an outer surface of the vessel to act as a source for a source for creating a temperature differential between the outer surface of the first vessel and the inner surface of the first vessel. In an embodiment, the preheating fluid may be a heat exchange fluid from the heat jacket about first vessel.

The system may further include a third pathway for directing processed fluid vapor exiting the first vessel back toward the heat jacket about the first vessel, in order to minimize energy consumption required to heat the first vessel. A compressor, in an embodiment, may be in fluid communication with the third pathway, for compressing the processed fluid vapor and thereby adding thermal energy to the processed fluid vapor being directed to the heat jacket.

In various embodiments, the system may further include: a) a second vessel, in spaced relation to the first vessel, for processing fluid along an inner surface thereof and for increasing processing throughput of the system, and b) a first vapor pathway for directing processed fluid vapor exiting the first vessel to a heat jacket situated about an outer surface of the second vessel, in order to minimize energy consumption required to heat the second vessel.

In various embodiments, a supply pathway may be included to direct the fluid to be processed in the second vessel from the fluid source toward the second vessel. In an embodiment, the fluid to be processed in the second vessel may be the same as the fluid to be processed in the first vessel. In another embodiment, the fluid to be processed in the second vessel may be different from the fluid to be processed in the first vessel.

The first vapor pathway, in an embodiment, may include a compressor for compressing the processed fluid vapor exiting the first vessel and thereby adding thermal energy to the processed fluid vapor being directed to the heat jacket about the second vessel. The system may further include a second vapor pathway for directing processed fluid vapor exiting the second vessel toward the heat jacket about the first vessel, in order to minimize energy consumption required to heat the first vessel.

The system may further include a processed fluid pathway for directing processed fluid from the first vessel into the second vessel, for further processing of the processed fluid.

In yet another aspect, the present disclosure is directed to a method for processing a fluid The method may comprise introducing, into a first vessel, a fluid being processed; distributing the fluid being processed against an inner surface of the first vessel in a controlled manner to form a substantially uniform thin film flow thereon; evaporating at least a portion of the fluid being processed flowing as a thin film along the inner surface; and removing, from the first vessel, vapor generated from evaporation of the fluid being processed.

The inner surface of the first vessel, in an embodiment, may be provided with a profiled pattern to create additional surface area over which the fluid being processed can flow to facilitate one of treatment, processing, separation, increase in residence time of the fluid being treated within the pathway, or a combination thereof. In another embodiment, the inner surface of the first vessel may be coated to facilitate treatment, processing, and/or separation of the fluid being processed. In an embodiment, the substantially uniform thin film flow may enhance ability of the fluid being processed to be treated, processed, and/or separated. In another embodiment, the fluid being processed may be permitted to exhibit a high rate of thermal transfer, mass transfer, mixing, or a combination thereof.

Distributing the fluid being processed against an inner surface of the first vessel may include rotationally dispensing within the first vessel substantially fine droplets or fiber-like elements of the fluid being processed. In an embodiment, the fluid may be dispensed lengthwise along the inner surface of the first vessel to minimize thinning of the fluid flow along the length of the inner surface and allow for controlled evaporation of the fluid.

In various embodiments, a temperature differential may be created between an outer surface of the first vessel and the inner surface of the first vessel. A heat jacket, in various embodiments, may be provided about an outer surface of the first vessel to act as a source for a source for creating a temperature differential between the outer surface of the first vessel and the inner surface of the first vessel 1.

Vapor removed from the first vessel may, in various embodiments, be compressed, and thermal energy allowed to be transferred from the compressed removed vapor to the heat jacket about the first vessel, in order to minimize energy consumption required to heat the first vessel.

In an embodiment, vapor removed from the first vessel may be compressed, and thermal energy allowed to transfer from the compressed removed vapor to a heat jacket of a second vessel, in order to minimize energy consumption required to heat the second vessel. In another embodiment, vapor exiting the second vessel may be compressed, thermal energy allowed to transfer from the compressed generated vapor to the heat jacket about the first vessel, in order to minimize energy consumption required to heat the first vessel.

In an embodiment, processed fluid may be removed from the first vessel, and thermal energy allowed to transfer from the removed processed fluid to the fluid being processed. In another embodiment, processed fluid may be removed from the first vessel and directed into a second vessel, in spaced relation to the first vessel, for further processing.

In various embodiments, the fluid being processed may be utilized in one of an evaporation or a distillation process, a desalination process, a vaporization process for reducing leachate produced in landfills, and a process for reducing a volume of produced and flow backwater generated by fracking natural gas extraction practices.

In still another aspect, the present disclosure is directed to a method for processing a fluid. The method may comprise introducing, into a first vessel, a fluid to be processed; processing the fluid within the first vessel; directing, from the first vessel, processed fluid into a second vessel downstream from the first vessel; and further processing the processed fluid from the first vessel within the second vessel.

Vapor generated from processing the fluid within the first vessel may, in an embodiment, be subsequently directed into a heat jacket situated about the second vessel in order to minimize energy consumption required to heat the second vessel. In an embodiment, the generated vapor may be compressed, and therefore provided with increased thermal energy, prior to being directed into the heat jacket about the second vessel. In an embodiment, the processed fluid may be preheated by processed fluid from the second vessel. In another embodiment, the processed fluid may be preheated by a heat exchange fluid from a heat jacket situated about the second vessel.

### BRIEF DESCRIPTION OF DRAWINGS

For a more complete understanding of this disclosure, reference is now made to the following description, taken in conjunction with the accompanying drawings, in which:

FIG. 1 illustrates a processing reactor according to one embodiment of the present invention.

FIG. 2 illustrates a processing reactor according to another embodiment.

FIG. 3 illustrates a processing reactor according to a third embodiment.

FIG. 4 illustrates a reactor stage according to one embodiment of the present invention.

FIG. 5 illustrates a two-stage processing system according to an embodiment.

FIG. 6 illustrates a two-stage processing system according to another embodiment.

FIG. 7 illustrates temperature to specific entropy relationships during vapor-to-liquid phase transitions.

### DESCRIPTION OF SPECIFIC EMBODIMENTS

Embodiments of the present disclosure generally provide a reactor 10 for processing a fluid, and various methods for processing a fluid.

### Reactor 10

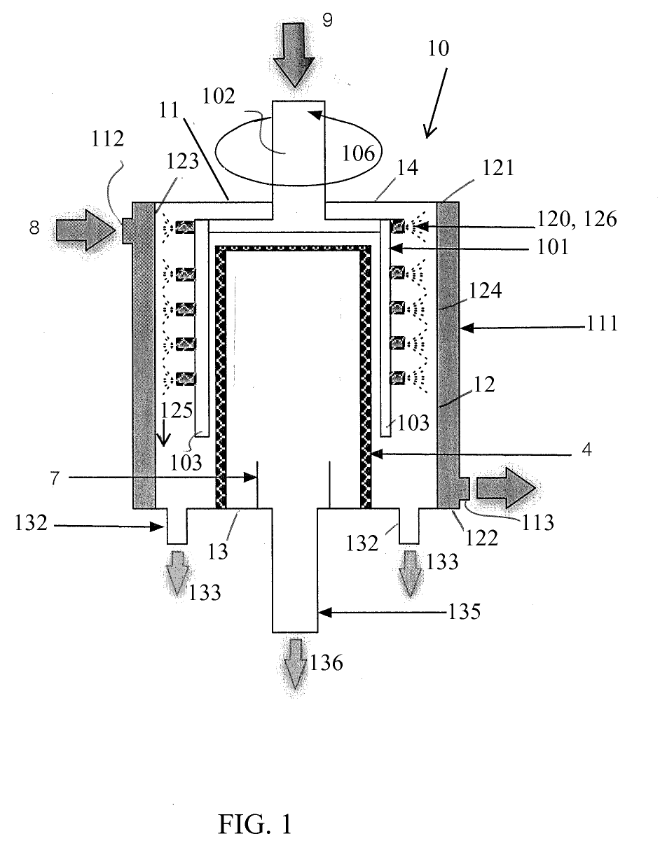

FIGS. 1-3 illustrate representative configurations of reactors 10, 20, 30, and parts thereof. It should be understood that the components of reactors 10, 20, 30, and parts thereof shown in FIGS. 1-3 are for illustrative purposes only, and that any other suitable components or subcomponents may be used in conjunction with or in lieu of the components comprising reactors 10, 20, 30, and the parts of reactors 10, 20, 30, described herein.

Looking now at FIG. 1, in accordance with one embodiment, there is illustrated a reactor 10 for, among other things, continuous processing, for example, controlled, uniform, thin film vapor generation for liquid volume reduction. As illustrated, reactor 10 includes a vessel 11 for accommodating fluids to be processed. The vessel 11, in an embodiment, includes a body portion 12 within which a fluid or fluids to be processed may be accommodated, and if desired, any material to be used in connection therewith. In one embodiment, the body portion 12 may be substantially cylindrical in shape and may include a top end 121 and a bottom end 122. The body portion 12 may also include an inner surface 123 (i.e., heat exchange surface) and an opposing outer surface 124 extending between top end 121 and bottom end 122 of the body portion 12. The inner surface 123, in an embodiment, may be designed so that a fluid being processed may be directed thereonto. In one embodiment, the fluid being processed may be permitted to flow down along the length of the inner surface 123, in the direction of arrows 125, in a thin film. The flow of fluid along inner surface 123, in an embodiment, may be facilitated, for instance, by gravitational force. By allowing the fluid to flow as a thin film, the fluid can be well suited for treatment, processing, and/or separation at a relatively high level of energy efficiency, while imparting the fluid with relatively high transport rates (i.e., thermal transfer, mass transfer and/or mixing rates). In accordance with one embodiment of the present invention, the thin film flow provided on the inner surface 123 of the vessel 11 may have a thickness ranging from approximately 1.0 micron to approximately 1.0 cm. However, it should be appreciated that a thickness less than the range provided or more than the range provided is also contemplated, depending on the particular application, as the reactor 10 of the present invention is not intended to be limited in this manner. Thickness of the thin film may, in some embodiments, be substantially uniform throughout the thin film flow.

As the vessel 11 may be designed to impart to the fluid being processed with relatively high transport rates, to the extent that there may be a desire to further enhance thermal transfer, mass transfer, mixing rates and/or other related high transport rates, the inner surface 123 may be profiled to create additional surface area over which the fluid being processed can flow. In particular, by providing additional surface area over which the fluid can flow, the residence time or time period over which thermal transfer can occur to or from the fluid can increase. The profiled pattern of inner surface 123 can also help to increase surface tension of the fluid flowing along inner surface 123 and can help to maintain a thin film of liquid along the inner surface 123. An example of a profiled pattern for the inner surface 123 includes grooves. The grooves, in an embodiment, may be situated horizontally, vertically, in a zig-zag pattern, or any other designs. Although grooves can be provided along inner surface 123, other profiled patterns can be provided, for instances, indentations, bumps, undulations, so long as the profiling patterns can help to enhance the transport rates.

In addition to or instead of providing the inner surface 123 of body portion 12 with a profiling pattern, the inner surface 123 may include a coating to facilitate treatment, processing, and/or separation, while providing the fluid flowing along the inner surface 123 with relatively high transport rates. In an embodiment, the coating may have any chemical, physical, electrical, magnetic, or other types of properties known in the art.

It should be appreciated that although illustrated as being cylindrical in shape, body portion 12 of vessel 11 may be provided with any shape or configuration, for example, triangular, square, hexagonal, octagonal, or any other geometric configuration at any desired length and diameter, and depending on the application. In addition, as the body portion 12 may need to withstand relatively high internal pressure, the vessel 11 and/or the body portion 12 may be made from any solid material, including metal, metal alloy, plastic, glass, quartz, ceramic, or any other solid materials that can withstand such pressure while permitting thermal transfer, be maintained at a certain temperature, and/or permit a change in temperature as necessary.

Still looking at FIG. 1, vessel 11 of reactor 10 may also include a bottom portion 13 designed to collect and remove, among other things, fluids that have traveled down along inner surface 123 of body portion 12.

To permit removal of processed fluid collected in bottom portion 13, at least one outlet 132 may be positioned at a location along the bottom portion 13, such that removal of the collected fluid can be sufficiently accomplished. In an embodiment, fluid removed from the bottom portion 13 may be collected in a catch basin (not shown) situated near outlet 132 or by any other means known in the art.

In one embodiment, bottom portion 13 may be provided with at least one exhaust, i.e. outlet, 135 to permit removal of any gas or vapor, including gas generated in connection with the processing of the fluid, flowing along inner surface 123 of body portion 12. In one embodiment, when the reactor 10 is used in an evaporative process, the exhaust outlet 135 can permit removal of vapor 136 generated from the evaporation of the fluid flowing along inner surface 123 of body portion 12. Once removed, the vapor 136 can be further vented, condensed or compressed.

As illustrated, bottom portion 13 may be flat in shape. However, it should be appreciated that bottom portion 13 may be conical, parabolic, or provided with any other geometric shape which can complement the geometric profile of the bottom end 122 of body portion 12. The bottom portion 13 can be made from any solid material similar to the material from which body portion 12 is made, including metal, metal alloy, plastic, glass, quartz, ceramic, or any other solid materials that can be maintained at a certain temperature, and/or permit a change in temperature as necessary.

Vessel 11 of reactor 10 may further include a top portion 14 for retaining evaporated vapor from fluids to be processed within the vessel 11. Also, the top portion 14 may be designed to introduce other fluid or fluids into the vessel 11 for use in connection with the fluid being processed.

In one embodiment, top portion 14 may be flat in shape. However, it should be appreciated that top portion 14 may be provided with any geometric shape which can complement the geometric profile of the top end 121 of body portion 12. Moreover, since the top portion 14 may need to withstand high pressure, it may be desirable to make the top portion 14 from any solid material similar to the material from which body portion 12 is made, including metal, metal alloy, plastic, glass, quartz, ceramic, or any other solid materials that can be maintained at a certain temperature, and/or permit a change in temperature as necessary.

It should be noted that although referenced herein as an exhaust, inlet, or outlet, these openings or apertures may be used to either introduce or remove fluid from the vessel 11.

As illustrated, vessel 11 may include a body portion 12 designed to provide a heat exchange surface within reactor 10. In particular, the body portion 12 may include an inner surface 123, and an opposing outer surface 124 along which a heat exchange fluid may flow in a direction that is counter, co-current or in a cross flow configuration with the downward flow of the fluid being processed. The flow of the heat exchange fluid along opposing outer surface 124, in an embodiment, may be facilitated, for instance, by gravitational force. In one embodiment, the heat exchange fluid flowing along the opposing outer surface 124 of vessel 11 may be provided at a different temperature relative the fluid being processed flowing along inner surface 123 of the vessel 11. This may impart a temperature differential between outer surface 124 and inner surface 123. By providing the heat exchange fluid with a different temperature, a predetermined amount of thermal energy can be introduced across the opposing outer surface 124 onto the inner surface 123 of vessel 11 to evaporate the fluid being processed and facilitate relatively high transport rates during treatment, processing and/or separation of the fluid flowing along the inner surface 123 of vessel 11. Examples of a heat exchange fluid include water, oil, glycol mix, Dow Therm™, or any fluid capable of carrying out heat exchange.

To further impart and enhance the transport rates of the fluid being processed along inner surface 123 of vessel 11, an energy source, such as heat pump jacket 111, may be provided about body portion 12 of vessel 11 to act as a source for heating or cooling the fluid flowing along the inner surface 123. For instance, if the evaporation of the descending fluid being processed results in a measurable change in temperature of the descending fluid, jacket 111 may be used to adjust the temperature of the descending fluid up or down, as appropriate, until the desired temperature is achieved to provide controlled evaporation of the fluid being processed along inner surface 123.

Jacket 111, in one embodiment, may be any commercially available heat pump, and may include inductive, resistive, or conductive elements for providing electromagnetic energy, such as microwave energy, to transfer thermal energy to the inner surface 123. The jacket 132 may further include additional components to improve the thermal performance. Alternatively, instead of a heat pump, jacket 111 may be designed to allow a fluid at a relatively raised temperature, e.g. steam or at a relatively cool temperature to run therethrough, in order to act as a source for heating or cooling the fluid flowing along the inner surface 123 of vessel 11. To that end, jacket 111 may include inlet 112, to permit gases, liquids, or other fluids to enter, and outlet 113, to permit the same to exit jacket 111. In an embodiment, jacket 111 may be made from metal, metal alloy, plastic, glass, quartz, ceramic, or any other materials that can maintain and impart heat or cold temperatures.

One of the advantages of the reactor 10 of the present invention is the ability to provide a controlled thin film flow along the inner surface 123 of vessel 11 to facilitate vapor generation for the fluid being processed. To do so, reactor 10 utilizes, in accordance with one embodiment, a fluid dispensing system 101, as illustrated in FIG. 1. Dispensing system 101, in an embodiment, may include a rotatable T-shaped pathway 102, designed to introduce the fluid being processed from a fluid source (not shown) into the interior of vessel 11. Dispensing system 101 may also include a plurality of fluid communicating members 103, such as feed arms, in fluid communication with pathway 102, so that fluid from pathway 102, if desired, can be continuously directed to and subsequently be dispensed by members 103 on to the inner surface 123 of the vessel 11. In one embodiment, the member 103 may be further provided with a plurality of ports 120 for dispensing the fluid to be processed towards the inner surface 123, such as spray nozzles 126 or openings 128 (not shown). In an embodiment, spray nozzles 126 may be adjustable nozzles or electronically controllable nozzles.

According to one embodiment, the ports 120 may be designed to dispense fluid onto the inner surface 123 such that the thin film of the fluid being processed is disturbed. This disturbance can enhance the processing of the fluid flow down the inner surface 123.

Still with reference to FIG. 1, the dispensing system 101 may be concentrically positioned within the vessel 11, such that the T-shaped pathway 102 and vessel 11 may be in substantial axial alignment with one another. According to one embodiment, when the dispensing system 101 dispenses the fluid to be processed towards the inner surface 123, the T-shaped pathway 102 can rotate about an axis in substantial axial alignment with the vessel 11. Alternatively, the vessel 11 can be rotated about an axis and the T-shaped pathway 102 can be kept stationary when the dispensing system 101 may dispense the fluid to be processed. According to another embodiment, the T-shaped pathway 102 and the vessel may be stationary while flow rate of the fluid to be processed may be varied to provide a thin film flow of the fluid to be processed along the inner surface 123.

In an embodiment, the size and diameter of the vessel 11, the spans of the T-shaped pathway 102, the lengths and diameters of the fluid communicating members 103, or any relative ratio of these dimensions to others can vary and can be determined depending on the particular application.

It should be appreciated that the fluid communicating members 103, in an embodiment, can be designed in such a manner that their rotation imparts a centrifugal action, so as to cause fluid received from pathway 102 to be directed outward toward a periphery (i.e., a side of the member 103 along its length proximal to the inner surface 123) of members 103. The rotation of member 103 can further cause the fluid at the periphery of member 103 to be continuously spun off the member 103 into substantially fine droplets or fiber-like elements and on to the inner surface 123 of vessel 11, through openings 128 (not shown) along the length of the members 103, or through spray nozzles 126. The continuous controlled provision of substantially fine droplets or fiber-like elements on to the inner surface 123 allows a thin film flow to be formed as the fluid being processed descends along the inner surface 123.

According to one embodiment, the placement of ports 120 along members 103 can minimize scaling due to heat applied to the inner surface 123. In particular, as the thin film of fluid moves down surface 123, the flow may thin out to a point where the heat from jacket 111 may dry out the thin film near the bottom of surface 123 and cause scaling. By placing the ports 120 in the manner shown in FIG. 1 (shown here as spray nozzles 126), fluid can be dispensed substantially along the length of surface 123 from top to bottom, in a controlled manner, to form a substantially uniform thin film flow, and thereby minimize thinning of the fluid flow and allow for controlled evaporation of the fluid. In an embodiment where a pathway 102 is stationary, additional members 103 can be provided about the pathway 102 with each member 103 having a plurality of ports 120. With additional members 103 and ports 120 to dispense fluid onto surface 123, the chance of scaling on the inner surface 123 can be minimized. It should be appreciated that the number of members 103 can be determined according to the potential coverage area of ports 120—that is, for example, the operating radius of the nozzles 126—and the total area of the inner surface 123. According to one embodiment, the plurality of members 103 and ports 120 can be arranged lengthwise along inner surface 123, which in some embodiments, may coincide with the depth of the vessel 11. According to another embodiment, the plurality of ports 120 may be arranged in a helical pattern within vessel 11. For example, one or more helical members 103 with openings 128 positioned thereon can be provided to dispense the fluid being processed onto the inner surface 123, or a helical arrangement of the nozzles 126 can be provided across the plurality of lengthwise members 103. It should be recognized that the present disclosure should not be limited to the particular embodiments set forth herein, and that dispensing system 101 may comprise any suitable configuration suitable to dispense the fluid substantially along the length of surface 123 from top to bottom, in a controlled manner, to minimize thinning of the fluid flow and allow for controlled evaporation of the fluid.

Dispensing system 101 may further include a motor (not shown) designed to actuate rotation of the T-shaped pathway 102, for instance, in the direction shown by arrow 106, and thus rotation of members 103. The motor, in an embodiment, may be coupled to an end of pathway 102 opposite that to which members 103 are positioned and may be designed to rotate at a sufficient rate. In one embodiment, the rate of rotation of the motor may be controlled so that the rate of rotation can be varied, as desired. For example, the rate can be varied in order to ensure a disturbed flow in a thin film when the flow rate of the fluid may have changed.

Vessel 11, according to an embodiment, also can be provided with a demister 4 to separate vapor generated from aerosolized liquid, i.e. fluid and liquid droplets, that exist in the vapor. The demister 4, according to one embodiment can be made from a filter material such as a carbon filter. The demister 4, in one embodiment, may be shaped into a substantially cylindrical baffle and can be placed over the opening of the outlet 135 through which vapor may be removed from vessel 11. Alternatively, the demister 4 can be shaped into any geometrical shape so long as it prevents aerosolized liquid or solid particles from exiting the vessel through outlet 135. In one embodiment, the demister can also be made from a material such as a carbon filter to be used to absorb light organics from the vapor being removed through outlet 135. Although not shown, it should be appreciated that the demister 4 can be, in one embodiment, shaped so as to cover the opening of the outlet 135 and placed across the opening of outlet 135. According to one embodiment, positioning of the demister between inner surface 123 and outlet 135 can also prevent droplets generated by back splash from being directed into outlet 135 and contaminate the vapor collected.

Looking still at FIG. 1, the vessel 11 can be further provided with a vertical baffle 7 placed concentrically about the outlet 135 so as to provide a barrier so that fluid 133, which may have been separated by the demister 4 and traveled down the demister towards outlet 135, can be prevented from exiting through outlet 135. It should be noted that demister 4 should be sufficiently porous to allow fluid collected about the baffle 7 to move across demister 4 towards outlet 132 for removal.

One advantage of the dispensing system according to the present invention is that it ensures a smooth distribution of fluid thin film and minimizes any hydraulic jump and consequently any liquid carryover to the vapor phase. This is achieved, in part, by dispensing system 101, which may use ports 120 arranged radially as well as along the depth of heat transfer surface, i.e. inner surface 123, so that liquid film thickness of the fluid being processes can be precisely managed. The designs of the dispensing systems, according to various embodiments of the present invention, may be further supplemented by, for example, electronically adjusting the volumetric flow of the liquid through each of the ports 120.

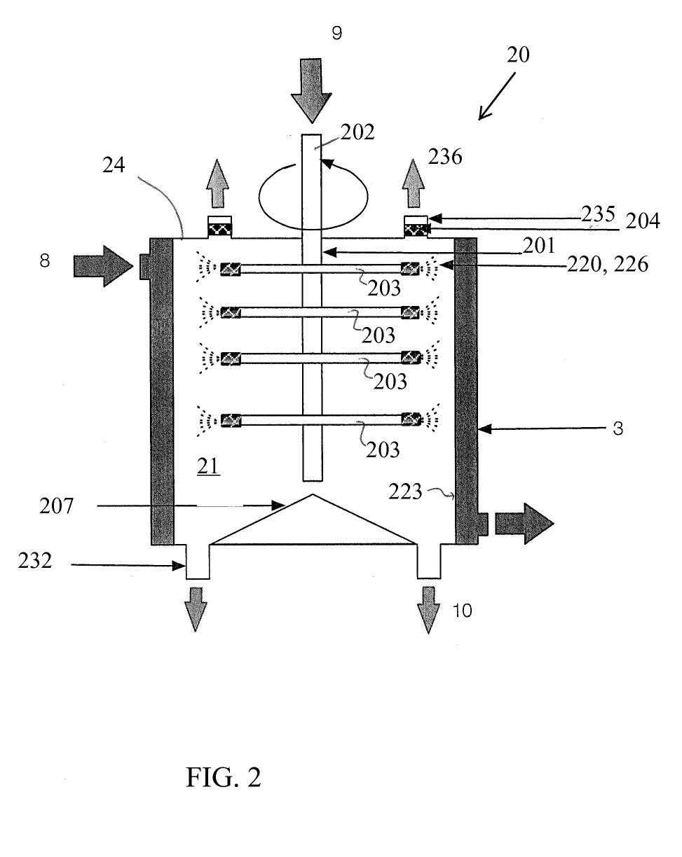

Looking at FIG. 2, according to another embodiment, reactor 20 can be provided with one or more vapor removal outlet 235 placed at top portion 24. According to one embodiment, demister 204 can be provided across the opening of the outlet 235 so as to prevent liquid or solid particles from exiting the vessel 21 through outlet 235.

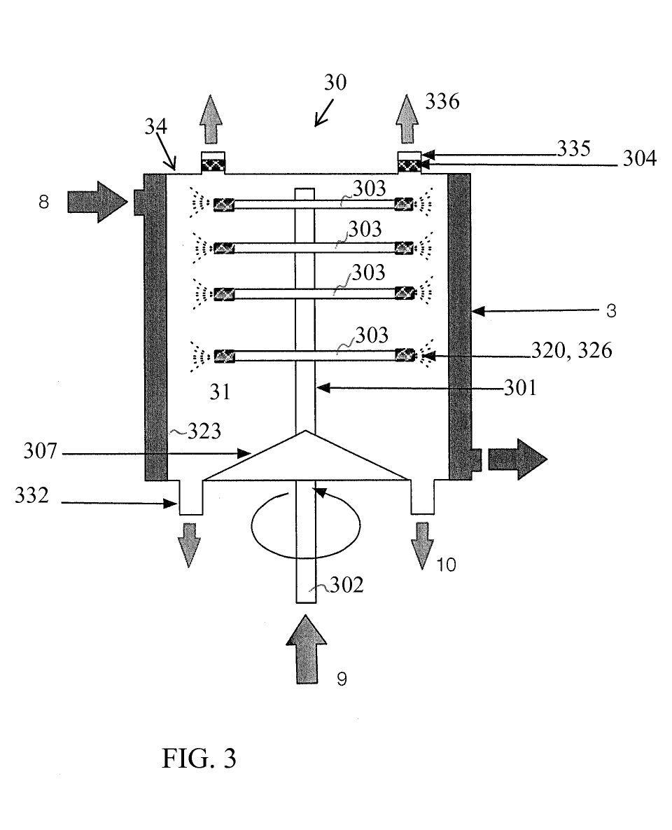

Similarly, looking at FIG. 3, according to one embodiment, reactor 30 can be provided with one or more vapor removal outlet 335 on the top portion 34. According to one embodiment, demister 304 can be provided across the opening of the outlet 335 so as to prevent liquid or solid particles from exiting the vessel 31 through outlet 335.

Looking again at FIG. 2, according to one embodiment, reactor 20 can be provided with a substantially conical body 207 designed to direct processed fluid towards fluid removal outlet 232.

According to the embodiment shown in FIG. 2, the dispensing system 201 may include a rotatable vertical pathway 202, designed to introduce the fluid being processed from a source (not shown) into the interior of vessel 21. Dispensing system 201 may also include a plurality of horizontal fluid communicating members 203, such as a tubing member, in fluid communication with pathway 202, so that fluid from pathway 202, if desired, can be continuously directed to and subsequently be dispensed by members 203 on to the inner surface 223 of the vessel 21. In one embodiment, the member 203 may be further provided with a plurality of ports 220, such as adjustable spray nozzles 226 or openings 228 (not shown), for dispensing the fluid to be processed towards the inner surface 223.

Looking now at FIG. 3, according to one embodiment, reactor 30 can be provided with a dispensing system 301 which combines with a liquid collector 307. In particular, the dispensing system 301 may include a rotatable vertical pathway 302, designed to introduce the fluid being processed from a source (not shown) into the interior of vessel 31. Dispensing system 301 may also include a plurality of horizontal fluid communicating members 303, such as a tubing member, in fluid communication with pathway 302, so that fluid from pathway 302, if desired, can be continuously directed to and subsequently be dispensed by members 303 on to the inner surface 323 of the vessel 31. In one embodiment, the member 303 may be further provided with a plurality of ports 320, such as adjustable spray nozzles 326 or openings 328 (not shown), for dispensing the fluid to be processed towards the inner surface 323.

### Operation

In operation, looking again at FIG. 1, a fluid being processed, in general, may be substantially continuously introduced into vessel 11 of reactor 10 through pathway 102. Next, the fluid being processed may be directed into the members 103 where, as a result of centrifugal force due to rotation of the members 103, it may be directed outward toward the periphery of members 103. The rotation of members 103 can further cause the fluid at the periphery to be continuously dispensed from the members 103, through openings 128 (not shown) along the length of the members 103, or through adjustable spray nozzles 126, as substantially fine droplets or fiber-like elements and on to the inner surface 123 of vessel 11. The continuous provision of substantially fine droplets or fiber-like elements on to the inner surface 123 allows a thin film flow to be formed as the fluid being processed descends along the inner surface 123. Additionally, as fluid continues to be dispensed, newly dispensed fluid onto inner surface 123 can disturb the thin film flow, and aid in reduction of scaling during evaporation and the processing of the fluid.

Once the fluid being processed is dispensed onto surface 123, a heat exchange fluid, at a temperature different from that of the fluid being processed, may be provided by the heat pump jacket 111 through outlet 112. In the presence of heat provided by the heat jacket the fluid being processed evaporates within the vessel 11. Subsequently, this heat exchange fluid may be directed exit the jacket 111 through inlet 113 so as to maintain a predetermined heat flux across the opposing outer surface 124 and onto the inner surface 123.

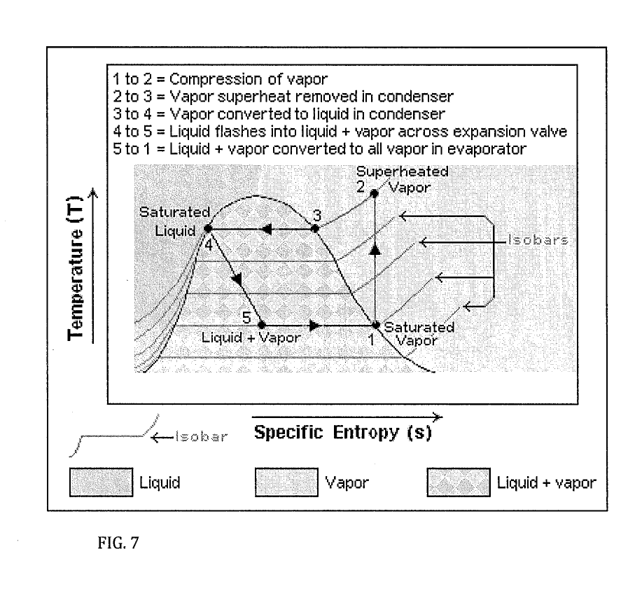

Vapor generated within vessel 11 can build up in pressure and such pressure can act to push the vapor across demister 4 towards an area of relatively low pressure, i.e. outlet 135. As vapor moves across demister 4, fluid droplets within the vapor may be trapped by the demister 4 and allowed to move down toward bottom portion 13 and directed towards outlet 132 for removal. In doing so, the demister 4 can minimize any hydraulic jump and consequently any liquid carryover to the vapor phase, thereby can ensure a smooth distribution of liquid thin film. According to one embodiment, vapor collected across the demister 4 may be removed by means of a blower or by means of a vacuum pump in communication with outlet 135. According to another embodiment, the vapor generated may be removed by means of a blower situated on top of the reactor and communicated with the vapor removal port thereon, as shown in FIGS. 2-3. As illustrated in FIG. 7, using a vacuum pump may create a negative pressure inside the reactor and may reduce the boiling point of the liquid being evaporated.

For any remaining fluid descending the surface 123, once it reaches bottom portion 13, it can be directed into outlet 132 and removed from vessel 11.

The design of the reactor 10 of the present invention, which provides a controlled thin film flow, an increase in the surface area as well as the residence time for which the fluid can be processed, i.e. evaporated, and the ability to impart a difference in temperature between the thin film fluid being processed and the heat exchange surface, can enhance treatment, processing and/or evaporation of the fluid being processed, while imparting such fluid with relatively high transport rates. In addition, because of the ability to continuously control thin film flow of fluid over a substantially large surface area, reactor 10 of the present invention can reduce scaling along the heat transfer surface, i.e. the inner surface 123 during evaporation, and can provide substantially high throughput processing of the fluid or fluids involved.

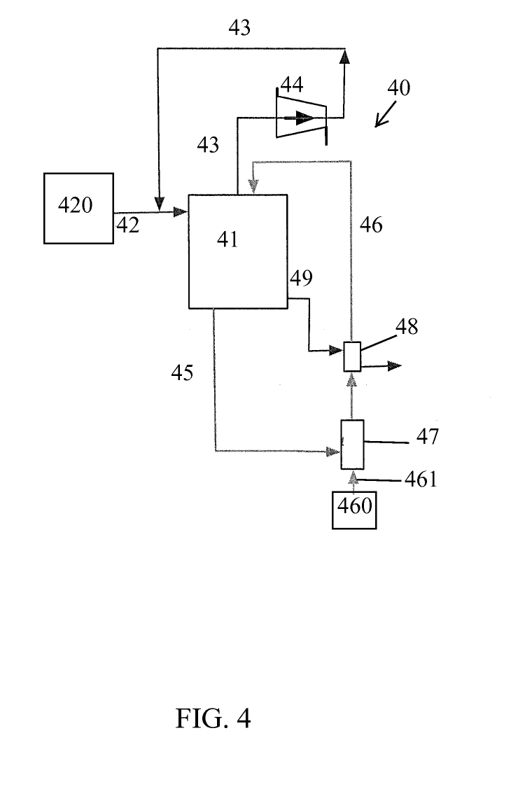

FIGS. 4-6 illustrate representative configurations of reactor systems 40, 50, 60, and parts thereof. It should be understood that the components of reactor systems 40, 50, 60, and parts thereof shown in FIGS. 4-6 are for illustrative purposes only, and that any other suitable components or subcomponents may be used in conjunction with or in lieu of the components comprising reactor systems 40, 50, 60, and the parts of reactor systems 40, 50, 60, described herein.

As illustrated in FIG. 4, a reactor system 40 is provided for processing fluid in accordance with an embodiment of the present invention. In particular, reactor 41 can be any of the reactors illustrated in FIGS. 1-3. According to one embodiment, a boiler 420 may be initially used to generate a supply of fluid vapor (i.e., a heat exchange fluid) to provide, via a pathway 42, thermal energy through the heat jacket to the reactor 41.

A fluid to be processed in reactor 41 may be provided by a supply pathway 461 from a fluid source 460. In an embodiment, a one or more heat exchangers, such as heat exchangers 47 and 48, may be in fluid communication with, and in proximity to, reactor 41 along pathway 46. In various embodiments, a pathway, such as pathway 45 or 49, may direct a heating fluid from reactor 41 to heat exchangers 47,48 to increase the temperatures of the heat exchangers, and thus, transfer heat from the heating fluid to the fluid to be processed. In an embodiment, the heating fluid may include processed fluid from reactor 41, which is directed via pathway 45 to heat exchanger 47. In another embodiment, the heating fluid may include the heat exchange fluid from the heat transfer jacket of reactor 41, such as that provided by boiler 420. In yet another embodiment, the heat exchange fluid may, additionally or alternatively, include vapor generated from processing the fluid in the reactor. For example, as later described, vapor generated within reactor 41 may be directed from reactor 41 back into the heat pump jacket of reactor 41 via pathway 43. In various embodiments, the fluid to be processed may be preheated via one or both of heat exchangers 47 and 48, as previously described, and in any suitable order.

The fluid to be processed may be directed along pathway 46 into reactor 41 for processing. Vapor generated from processing the fluid can be directed out of reactor 41 along pathway 43, and in an embodiment, into compressor 44. The vapor may gain thermal energy in the form of heat by being compressed by the compressor 44. This heating process is also illustrated in FIG. 7, with respect to transition “1 to 2.” The heated, compressed vapor may then be returned to the heat transfer jacket of reactor 41 by way of path 43, and may be used to heat reactor 41.

One advantage of reactor system 40, according to the present invention, is that boiler 420, used to supply thermal energy to the reactor 41, may be operated at a reduced energy consumption level after reactor 41 begins a continuous operation. According to one embodiment, boiler 420 may be initially used to generate a supply of vapor to provide thermal energy through the heat jacket of reactor 41. As reactor 41 evaporates a fluid, the condensed (i.e., processed) fluid, the vapor from boiler 420, and the vapor generated from the fluid may be sources of thermal energy for system 40 for subsequent processing. Furthermore, as generated vapor exits the reactor 41, thermal energy can be more efficiently added to the generated vapor by mechanical compressor 44 when compared with the energy efficiency of boiler 420. Subsequently, according to one embodiment, vapor produced from the evaporation process inside reactor 41 may be compressed again and fed back into the heat jacket of reactor 41. This cycling of vapor can reduce or eliminate the need of an external boiler, such as boiler 420, once the reactor 41 has begun its continuous processing, i.e. evaporation.

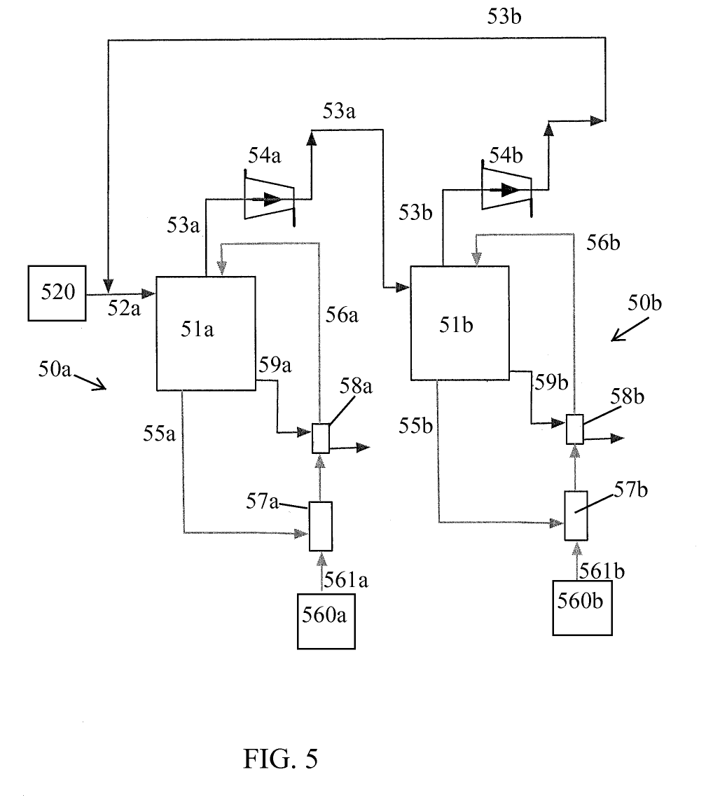

According to another embodiment, the design of FIG. 4 can be used in conjunction with one or more additional reactors to increase throughput of the process of the present invention. Looking at FIG. 5, each reactor 51a, 51b may be in fluid communication with a fluid source 560 of a fluid to be processed. One or more supply pathways 561 may direct fluid to be processed toward reactor 51 from fluid source 560. The term “fluid source” is used broadly herein, and may refer to any reservoir(s), container(s), conduit(s), or similar structure, or a combination thereof, configured to accommodate one or more fluids to be processed. For example, fluid source 560 may comprise a single reservoir containing either a single fluid, or multiple fluids (perhaps separated from one another by walls defining sub-reservoirs) to be processed. As another example, as shown in FIG. 5, fluid source 560 may comprise multiple reservoirs 560a, 560b, each containing a common fluid type, or alternatively, different fluids to be processed. Use of multiple reactors 51 may serve to increase processing throughput of fluid(s) to be processed from fluid source 560 by system 50. A boiler 520 can be used to provide a heat exchange fluid, such as steam, as a heating fluid for the heat jacket of reactor 51a.

Reactors 51a and 51b may be in series and placed in circular fluid communication with one another to enhance the efficient use of heat within system 50. In particular, system 50 may comprise a pathway 53a for directing vapor removed from reactor 51a to a heat jacket of reactor 51b to help reactor 51b evaporate incoming fluid to be processed being fed into reactor 51b from source 560b via pathway 561b. In an embodiment, compressor 54a along pathway 53a may compress the removed vapor before it is fed into the heat transfer jacket of the reactor 51b. Similarly, vapor removed from reactor 51b may, in an embodiment, be compressed by compressor 54b, and then fed into the heat transfer jacket of reactor 51a via pathway 53b, thereby completing a circular communication between the two reactors 51a and 51b, and in an embodiment, systems 50a and 50b. It should be appreciated that any number of reactor stages 50 can be circularly communicated according to the present invention, thereby increasing the total throughput of the processing provided by the reactor stages and promoting the efficient use of heat across system 50.

It should also be appreciated that thermal energy from fluids, such as a heating fluid (i.e., processed fluid from reactors 51a, 51b, condensed vapors from boiler 520, and/or generated vapor from reactors 51a,51b), may be used to preheat the fluid to be processed as it is directed from fluid source 560 towards reactors 51a,51b. For example, a heating fluid may be directed from reactors 51a,51b toward heat exchangers 57a,58a and 57b,58b via pathways 55a,59a and 55b,59b to increase the temperature of those heat exchangers. Meanwhile, the fluid to be processed is received from supply pathways 561a,561b and preheated by heat exchangers 57a,58a and 57b,58b before being directed toward reactors 51a, 51b along pathways 56a, 56b. It should be further appreciated that a fewer number of heat exchangers can be used to transfer the thermal energy from the removed processed fluid and the heating fluid.

One advantage of the circularly communicated reactor systems 50a, 50b, as illustrated in FIG. 5, is that the thermal energy from the processed fluid steam and the condensed vapor from the heat jacket may be recovered to preheat the incoming feed fluid to be processed, thereby achieving a high recovery rate. In these embodiments, each unit stage of reactor may be capable of achieving approximately 60% recovery rate depending on the liquid flow rate (production of vapor from liquid). Another advantage is that since a high energy recovery rate may be possible, the reactor stages may be operated without an external boiler once the heat transfer is initiated and a steady state continuous processing is achieved.

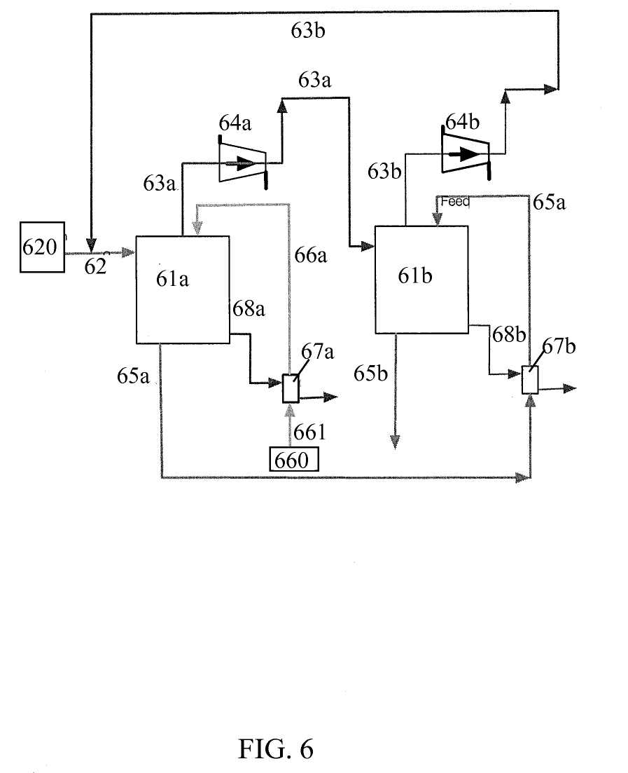

Now looking at FIG. 6, according to one embodiment, a first reactor system 60a may be communicated in series with a second reactor system 60b to further process a fluid, e.g. further evaporation or distillation, so as to remove a substantial amount of fluid, for instance water, and provide a relatively high concentrated product that can be subsequently disposed.

According to one embodiment, a boiler 620 can be used to provide, via pathway 62, steam as a heat exchange fluid for the heat jacket of reactor 61a. Hot condensed steam from heat jacket of the reactor 61a may be directed via pathway 68a to heat exchanger 67a to preheat incoming fluid to be processed received by heat exchanger 67a from fluid source 660 via supply pathway 661. The fluid to be processed may then be directed towards reactor 61a via pathway 66a, and dispensed along an inner surface of the reactor 61a. In the presence of heat from the heat jacket, fluid traveling along the inner surface of the reactor 61a is evaporated and vapor is generated. The vapor can be removed from reactor 61a and directed via pathway 63a to, in an embodiment, compressor 64a. Compressor 64a may then compress the vapor so as to provide additional thermal energy into the vapor before the vapor is directed into the heat jacket of reactor 61b via pathway 63a. This process may be reciprocated as previously described (i.e., vapor removed from reactor 61b may be directed along pathway 63b, through compressor 64b, and into a heat jacket of reactor 61a), similar to the circular arrangement of reactor stages in FIG. 5. However, unlike FIG. 5, here in FIG. 6, processed fluid from reactor 61a is directed along pathway 65a fed into reactor 61b for further evaporation, and a final distilled fluid is provided, which may be removed from reactor 61b via pathway 65b.

In particular, according to the embodiment shown in FIG. 6, processed fluid may be removed from reactor 61a, and may be subsequently fed into reactor 61b for further processing, i.e. further evaporation, via pathway 65a. This incoming fluid feed for reactor 61b, i.e. processed fluid from reactor 61a, can be preheated by a heat exchanger 67b, which may be in fluid communication with the heat jacket of reactor 61b and receive thermal energy from a heating fluid provided therefrom (i.e., the hot condensed steam removed from the heat jacket of reactor 61b). As the fluid may be further processed by reactor 61b, i.e. further evaporated, a relatively high concentrate level product, which may be in a slurry-like state by this point, may be removed from reactor 61b for further disposal via pathway 65b.

One advantage of embodiment illustrated in FIG. 6 is that the distillation or evaporation of the fluid may be maximized such that the physical weight of the processed fluid can be minimal, which may benefit subsequent disposal including further chemical treatment or physical transportation.

The reactors described above, with respect to FIGS. 1-6, can be used in a number of evaporation or distillation applications. For example, the reactors described above can be provided as a fruit juice concentrator, in which water vapor can be extracted from the juice thereby concentrating the juice. Also, the vapor generated can be compressed and used in mechanical vapor compression technologies such as desalination of briny water. Also, the reactors can be provided to reduce the volume of leachate produced in landfills by vaporizing the water. As another example, the reactors can be provided to reduce the volume of produced and flow backwater generated during a natural gas fracking process.

While the present invention has been described with reference to certain embodiments thereof, it should be understood by those skilled in the art that various changes may be made and equivalents may be substituted without departing from the true spirit and scope of the invention. In addition, many modifications may be made to adapt to a particular situation, indication, material and composition of matter, process step or steps, without departing from the spirit and scope of the present invention. All such modifications are intended to be within the scope of the claims appended hereto.

What is claimed is:

1. A reactor comprising:
a vessel having an inner surface serving as a heat exchange surface for a fluid being processed and along which the fluid being processed can form a thin film flow;
a fluid dispensing system, situated within the vessel, having a plurality of ports directed toward the inner surface and being arranged lengthwise along the inner surface to distribute the fluid being processed against the inner surface in a controlled manner to maintain substantially uniform thin film flow along the length of the inner surface; and
an outlet for removing, from the vessel, vapor generated from the fluid being processed.

2. A reactor as set forth in claim 1, wherein the inner surface of the vessel includes a profiled pattern to create additional surface area over which the fluid being processed can flow to facilitate one of treatment, processing, separation, an increase in residence time, or a combination thereof.

3. A reactor as set forth in claim 1, wherein the inner surface of the vessel is coated to facilitate treatment, processing, and/or separation of the fluid being processed.

4. A reactor as set forth in claim 1, wherein the fluid dispensing system is rotatable so that substantially fine droplets or fiber-like elements from the fluid being processed can be dispensed from the ports.

5. A reactor as set forth in claim 1, wherein the plurality of ports are arranged in a helical pattern lengthwise along the inner surface of the vessel.

6. A reactor as set forth in claim 1, wherein the substantially uniform thin film permits the fluid being processed to exhibit a high rate of one of thermal transfer, mass transfer, mixing, or a combination thereof.

7. A reactor as set forth in claim 1, wherein the substantially uniform thin film enhances the ability of the fluid being processed to be treated, processed, and/or separated.

8. A reactor as set forth in claim 1, further including an outlet positioned on a bottom portion of the vessel for removing processed fluid from the vessel.

9. A reactor as set forth in claim 8, wherein the outlet for removing generated vapor is positioned on the bottom portion of the vessel.

10. A reactor as set forth in claim 8, wherein the outlet for removing generated vapor is positioned on a top portion of the vessel.

11. A reactor as set forth in claim 1, further including a demister for separating aerosolized fluid from the generated vapor.

12. A reactor as set forth in claim 11, wherein the demister is substantially cylindrical in shape and placed over the outlet through which vapor generated from the fluid being processed is removed from the vessel.

13. A reactor as set forth in claim 11, wherein the demister is positioned across an opening of the outlet.

14. A reactor as set forth in claim 11, wherein the demister, being positioned between the inner surface of the vessel and the outlet, minimizes droplets generated by backsplash from being directed into the outlet.

15. A reactor as set forth in claim 1, further including a baffle placed within the vessel about the outlet, so as to provide a barrier that prevents fluid separated from the generated vapor by the demister from exiting through the outlet.

16. A reactor as set forth in claim 1, wherein the vessel includes an outer surface along which a heat exchange fluid may be in contact, the heat exchange fluid having a temperature different from that of the fluid being processed to impart a temperature differential between the outer surface and the inner surface of the vessel.

17. A reactor as set forth in claim 1, wherein the vessel includes an energy source provided about an outer surface of the vessel to act as a source for creating a temperature differential between the outer surface of the vessel and the inner surface of the vessel.

18. A reactor as set forth in claim 17, wherein the energy source includes a jacket.

19. A system for processing a fluid, the system comprising:
a fluid source for accommodating a fluid to be processed;
a first vessel for processing the fluid from the fluid source, the first vessel having an interior surface against which the fluid to be processed is directed in a thin film flow;
a heat exchanger, in fluid communication with and located in proximity to the first vessel, for preheating the fluid to be processed from the fluid source;
a first pathway for directing a preheating fluid from the first vessel to the heat exchanger to increase the temperature of the heat exchanger; and
a second pathway for directing the fluid to be processed received from the fluid source and heated by the heat exchanger, toward the first vessel for processing.

20. A system as set forth in claim 19, wherein the preheating fluid is processed fluid from the first vessel.

21. A system as set forth in claim 19, further including a jacket situated about an outer surface of the first vessel to act as a source for creating a temperature differential between the outer surface of the first vessel and the inner surface of the first vessel.

22. A system as set forth in claim 21, wherein the preheating fluid is a heat exchange fluid from the jacket about first vessel.

23. A system as set forth in claim 21, further including a third pathway for directing processed fluid vapor exiting the first vessel back toward the jacket about the first vessel, in order to minimize energy consumption required to heat the first vessel.

24. A system as set forth in claim 23, further including a compressor, in fluid communication with the third pathway, for compressing the processed fluid vapor and thereby adding thermal energy to the processed fluid vapor being directed to the jacket.

25. A system as set forth in claim 21, further including: a) a second vessel, in spaced relation to the first vessel, for processing fluid along an inner surface thereof and for increasing processing throughput of the system, and b) a first vapor pathway for directing processed fluid vapor exiting the first vessel to a jacket situated about an outer surface of the second vessel, in order to minimize energy consumption required to heat the second vessel.

26. A system as set forth in claim 25, further including a supply pathway to direct the fluid to be processed in the second vessel from the fluid source toward the second vessel.

27. A system as set forth in claim 26, wherein the fluid to be processed in the second vessel is the same as the fluid to be processed in the first vessel.

28. A system as set forth in claim 26, wherein the fluid to be processed in the second vessel is different from the fluid to be processed in the first vessel.

29. A system as set forth in claim 25, wherein the first vapor pathway includes a compressor for compressing the processed fluid vapor exiting the first vessel and thereby adding thermal energy to the processed fluid vapor being directed to the jacket about the second vessel.

30. A system as set forth in claim 25, further including a second vapor pathway for directing processed fluid vapor exiting the second vessel toward the jacket about the first vessel, in order to minimize energy consumption required to heat the first vessel.

31. A system as set forth in claim 25, further including a processed fluid pathway for directing processed fluid from the first vessel into the second vessel, for further processing of the processed fluid.

32. A method for processing a fluid, the method comprising:
introducing, into a first vessel, a fluid being processed;
distributing the fluid being processed against an inner surface of the first vessel in a controlled manner to form a substantially uniform thin film flow thereon;
evaporating at least a portion of the fluid being processed flowing as a thin film along the inner surface; and
removing, from the first vessel, vapor generated from evaporation of the fluid being processed.

33. A method as set forth in claim 32, wherein the step of introducing includes providing the inner surface of the first vessel with a profiled pattern to create additional surface area over which the fluid being processed can flow to facilitate one of treatment, processing, separation, increase in residence time of the fluid being treated within the pathway, or a combination thereof.

34. A method as set forth in claim 32, wherein the step of introducing includes coating the inner surface of the first vessel to facilitate treatment, processing, and/or separation of the fluid being processed.

35. A method as set forth in claim 32, wherein, in the step of distributing, the substantially uniform thin film flow enhances ability of the fluid being processed to be treated, processed, and/or separated.

36. A method as set forth in claim 32, wherein the step of distributing includes permitting the fluid being processed to exhibit a high rate of thermal transfer, mass transfer, mixing, or a combination thereof.

37. A method as set forth in claim 32, wherein the step of distributing includes rotationally dispensing within the first vessel substantially fine droplets or fiber-like elements of the fluid being processed.

38. A method as set forth in claim 32, wherein the step of distributing includes dispensing the fluid to be processed lengthwise along the inner surface of the first vessel to minimize thinning of the fluid flow along the length of the inner surface and allow for controlled evaporation of the fluid.

39. A method as set forth in claim 32, wherein the step of evaporating includes creating a temperature differential between an outer surface of the first vessel and the inner surface of the first vessel.

40. A method as set forth in claim 39, further including providing a jacket about an outer surface of the first vessel to act as a source for creating the temperature differential between the outer surface of the first vessel and the inner surface of the first vessel.

41. A method as set forth in claim 40, wherein the step of removing includes compressing the removed vapor, and allowing thermal energy to be transferred from the compressed removed vapor to the jacket about the first vessel, in order to minimize energy consumption required to heat the first vessel.

42. A method as set forth in claim 40, wherein the step of removing includes compressing the removed vapor, and allowing thermal energy to be transferred from the compressed removed vapor to a jacket of a second vessel, in order to minimize energy consumption required to heat the second vessel.

43. A method as set forth in claim 42, further including compressing generated vapor exiting the second vessel, and allowing thermal energy to be transferred from the compressed generated vapor to the jacket about the first vessel, in order to minimize energy consumption required to heat the first vessel.

44. A method as set forth in claim 32, further including removing, from the first vessel, processed fluid, and allowing thermal energy to be transferred from the removed processed fluid to the fluid being processed.

45. A method as set forth in claim 32, further including removing, from the first vessel, processed fluid, and directing the removed processed fluid into a second vessel, in spaced relation to the first vessel, for further processing.

46. A method as set forth in claim 32, wherein the fluid being processed is utilized in one of an evaporation or a distillation process, a desalination process, a vaporization process for reducing leachate produced in landfills, and a process for reducing a volume of produced and flow backwater generated by fracking natural gas extraction practices.

47. A method for processing a fluid, the method comprising:
introducing, into a first vessel, a fluid to be processed;
processing the fluid within the first vessel;
directing, from the first vessel, processed fluid into a second vessel downstream from the first vessel; and
further processing the processed fluid from the first vessel within the second vessel.

48. A method as set forth in claim 47, wherein in the step of processing, vapor generated from processing the fluid within the first vessel is subsequently directed into a jacket situated about the second vessel in order to minimize energy consumption required to heat the second vessel.

49. A method as set forth in claim 48, wherein the generated vapor is compressed, and therefore provided with increased thermal energy, prior to being directed into the jacket about the second vessel.

50. A method as set forth in claim 47, wherein in the step of directing, the processed fluid is preheated by processed fluid from the second vessel.

51. A method as set forth in claim 47, wherein in the step of directing, the processed fluid is preheated by a heat exchange fluid from a jacket situated about the second vessel.
